(19) United States
(12) Patent Application Publication
(10) Pub. No.: US 2024/0330743 A1
(43) Pub. Date: Oct. 3, 2024

(54) SYNTHESIS AND AUGMENTATION OF TRAINING DATA FOR SUPPLY CHAIN OPTIMIZATION

(71) Applicant: X Development LLC, Mountain View, CA (US)

(72) Inventors: David Andre, San Francisco, CA (US); Grace Taixi Brentano, Redwood City, CA (US); Lam Thanh Nguyen, Mountain View, CA (US); Salil Vijaykumar Pradhan, San Jose, CA (US); Peter Michael Aronow, Bernardsville, NJ (US)

(21) Appl. No.: 18/129,416

(22) Filed: Mar. 31, 2023

(51) Int. Cl. G06N 20/00

(52) U.S. Cl. CPC G06N 20/00

(57) ABSTRACT

Methods, systems, and apparatus, including computer programs encoded on a computer storage medium, for generating synthetic training data representing network disruptions. One of the methods includes obtaining data representing one or more first travel time distributions between at the at least two entities in the supply chain network. Synthetic network disruption data is generated including sampling from one or more second travel time distributions corresponding respectively to one or more simulated network disruptions. A second dataset having the synthetic network disruption data is generated, and a network policy agent is trained using the second dataset.

### BACKGROUND

In multi-agent networks, such as supply chain networks, unexpected disruptions may occur that cause delays in the networks and negatively impact operations within such networks. Such disruptions may include natural disasters, including but not limited to snowstorms, hurricanes, tornadoes, or other adverse or unexpected weather patterns. The disruptions may also include, but are not limited to, shortages in supply and/or demand for various resources and/or goods, employee strikes, employee shortages, other types of labor shortages, traffic and other transport conditions, and other atypical conditions in the operation of a multi-agent network. Sometimes, the multi-agent networks may not adequately anticipate such disruptions, which in turn causes non-optimal results for the networks.

### SUMMARY

In general, an aspect of the subject matter described in this specification relates to machine learning techniques for simulating events, e.g., disruptions, in a multi-agent network, such as a supply chain network. Hereinafter, multi-agent networks are referred to as supply chain networks, although the disclosed techniques apply to various other types of multi-agent networks. Using the disclosed techniques, various types of disruptions can be modeled for a supply chain network and used to modify local policies of the supply chain network to optimize operations and the network's ability to adapt to and operate in adverse or unexpected conditions. In this specification, a synthetic disruption in the context of a simulation of a supply chain network means any sustained condition that may or may not be reflected in historical data used to build the simulation of the supply chain network. Synthetic disruption data is data representing events that adversely affect performance of the supply chain network according to a performance metric, e.g., average delivery time, delivery or other shipping costs (e.g., monetary cost, labor cost, carbon impact, other environmental costs), worst-case delivery times, Nth percentile-case delivery times, stop-out percentages, or estimated lost-revenue amounts. Modeling such adverse conditions can allow the disclosed technology to generate data for making the supply chain network (and optionally other supply chains) robust to similar disruptions in the real-world and in the future. However, synthetic disruption data can also represent increases in supply chain capabilities that may not be reflected in the historical data, e.g., a new route or a new factory, a new carrier or shipping entity becomes available to provide services in the supply chain network. Modeling such non-adverse conditions can also allow the disclosed technology to generate data for making the supply chain network (and optionally other supply chains) more agile to advantageous changes.

Robust synthetic training data can be generated and used to train models, such as network policy agents as described herein, that simulate disruptions in the supply chain network. The resulting models can therefore accurately identify and respond to various types of disruptions, regardless of whether those disruptions previously affected the supply chain network or may affect the supply chain network in the future. Responding to disruptions can include generating recommendations that improve local policies of the supply chain network and/or reorganize operations of the network so as to avoid being set back or negatively impacted by such disruptions.

The disclosed techniques may include inserting and simulating disruptions from a variety of data sources during model training. Synthetic training data can be generated from the data sources, then used in the model training. The data sources may include, but are not limited to, historic data associated with a particular supply chain network, historic data associated with other supply chain networks, user input, and/or random data about supply chains and/or different types of disruptions. During training, the model can simulate a variety of potential fixes to operations of the supply chain network to accurately and efficiently identify optimal ways to improve the network's operations during real-time disruptions. Accordingly, the disclosed techniques can be used to learn how to effectively and accurately navigate and handle different types of future disruptions.

Moreover, testing a variety of disruptions in a simulated environment (where those disruptions are ones that a supply chain network would want to avoid) can encourage innovation in the supply chain network without the network having to experience such disruptions in the real world. Furthermore, the disclosed techniques provide the supply chain network with automated cost-benefit analysis that takes into consideration large sets of data. This automated cost-benefit analysis can beneficially help the supply chain network dial in a preferred amount of over-caution (or under-caution in some situations) for real-world application of the supply chain network's policies and operations.

Simulation of supply chain networks with various disruptions as described herein can allow efficient planning and re-planning of control policies and operations of the networks so that multiple entities in the networks can optimize their operations and consequently optimize the overall networks. Performing the disclosed techniques may aid in building flexible and resilient supply chain networks. Simulations that more accurately reflect potential real-world disruptions provide simulated results that better prepare the networks to adapt to any type of disruption and/or avoid less-optimal operation during real-world disruptions.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1A is a conceptual diagram of an example system for simulating events in a supply chain network.

FIG. 1B illustrates a block diagram of an example system in a supply chain network.

FIG. 2 is a flowchart of a process for simulating disruptions in a supply chain network.

FIG. 3 is a flowchart of a process for training the model of FIG. 2 with user input.

FIG. 4 is a flowchart of a process for training the model of FIG. 2 with adversarial agents.

Like reference symbols in the various drawings indicate like elements.

### DETAILED DESCRIPTION

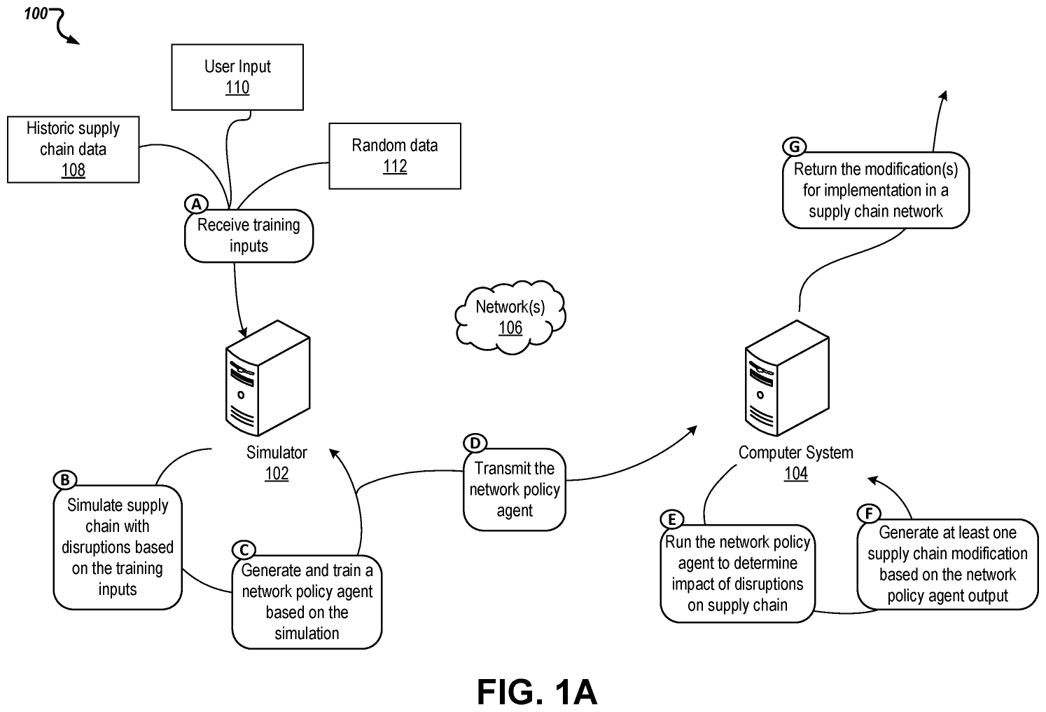

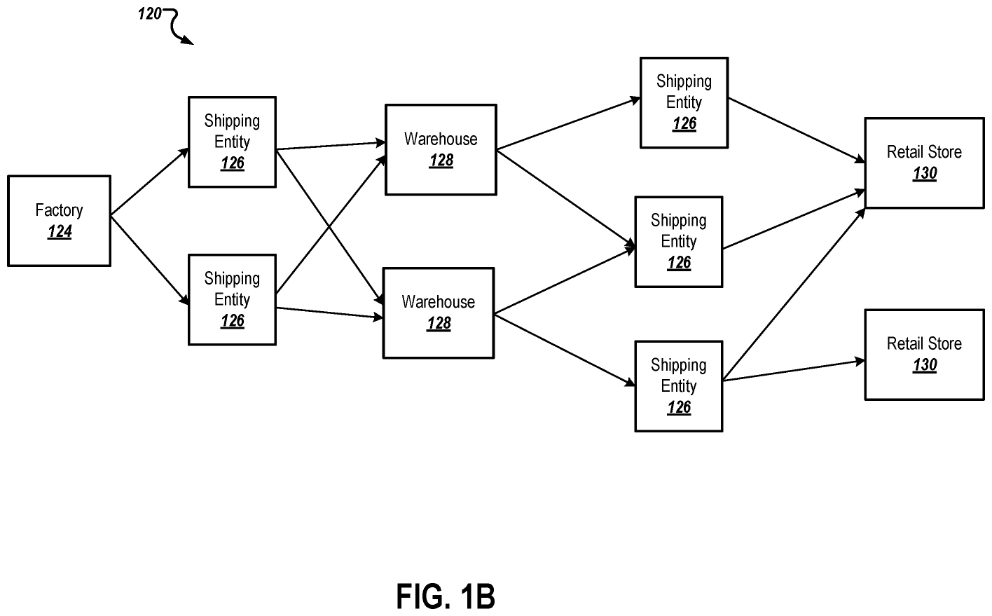

FIG. 1A is a conceptual diagram of an example system 100 for simulating events in a supply chain network. As described herein, the simulated events include disruptions. The system 100 includes various components, such as a simulator 102 and a computer system 104. In some implementations, the simulator 102 and the computer system 104 can be part of a same system and/or network of computing devices and/or systems.

The simulator 102 can be any type of computing device, computing system, cloud-based system, software, and/or network of computing devices/systems that is configured to train network policy agents, or machine learning models described throughout this disclosure. The simulator 102 can generate synthetic training data and train at least one network policy agent with the synthetic training data (and optionally with other/additional data, such as historic supply chain data, user input, and/or random data). The network policy agent can be trained to simulate various types of disruptions that may occur to a supply chain network, such as the supply chain network of FIG. 1B. The network policy agent can also be trained to generate at least one recommendation and/or modification to local policies of the supply chain network to optimize operations of the network and/or prevent the network from being negatively impacted or set back by real-world disruptions. A variety of disruptions are possible, including but not limited to natural disasters, unexpected conditions in the supply chain network (e.g., traffic), and/or other conditions or factors that may affect various entities (e.g., producers, shippers, suppliers, warehouses, and/or retailers) in the supply chain network. Although the disclosed techniques are described in reference to the supply chain network of FIG. 1B, the disclosed techniques are also applicable to various other types of multi-agent systems.

The computer system 104 can be any type of computing device, computing system, cloud-based system, software, and/or network of computing devices/systems that is configured to run the trained network policy agent and determine one or more modifications to the supply chain network's policies and/or operations to counteract effects of real-world disruptions, whether the disruptions are occurring, expected to occur, or predicted to occur. Therefore, the computer system 104's generated recommendation(s) can be implemented to help the supply chain network adapt to real-world disruptions without being set back in operation and optimization.

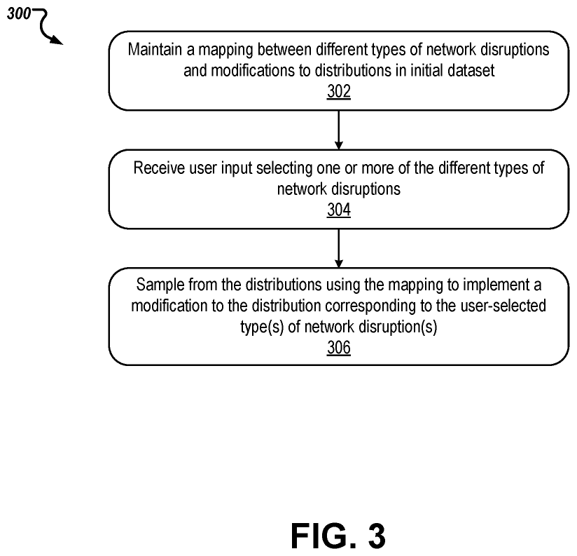

Still referring to FIG. 1A, the simulator 102 can receive training inputs in block A. The training inputs can be any one or more types of data. For example, the training inputs can include historic supply chain data 108. Additionally or alternatively, the training inputs can include user input 110 (refer to FIG. 3 for further discussion). Additionally or alternatively, the training inputs can include random data 112.

Regarding the historic supply chain data 108, often supply chain networks or particular entities within the network, such as a shipping company, can maintain historic data about their operations, policies, and/or activities in the particular supply chain network. The historic supply chain data 108 can indicate how the particular entity experienced and/or responded to particular real-world disruptions in the past and/or over time. This information may be used to simulate how the particular entity (and/or the whole supply chain network) may respond to future types of disruptions that are the same or similar. The historic supply chain data 108 can further be augmented using existing data, such as other history supply chain data, the user input 110, and/or the random data 112. The historic supply chain data 108 can additionally or alternatively be used to create new synthetic supply chain data, which can then be used to simulate various types of disruptions that may arise in the future.

The user input 110 can be provided by a user (e.g., relevant stakeholder in the supply chain network) through a programming language or natural language interface presented at a computing device (e.g., laptop, tablet, mobile phone, smart phone, computer). The user can specify one or more constraints (such as optimism and/or pessimism that certain disruptions will occur and/or have certain effects on the supply chain network) and/or rules (such as tuning a level of risk tolerance so that a preferred amount of disruptions is anticipated) for simulating and modeling disruptions for the particular supply chain network. More specifically, the user input 110 can specify nature, distribution, and/or severity of disruptions to be simulated for the particular supply chain network.

As an illustrative example, the user input 110 can indicate that hurricanes should be considered as a disruption to transportation of goods while thunderstorms should be ignored. As another example, the user input 110 can indicate a likelihood of certain disruptions or events occurring in the supply chain network. The user input 110 can indicate at least one disruption that may be possible and conditional on other events occurring or having occurred. As yet another example, the user input 110 can suggest that the model be trained based on one or more random perturbations or particular use cases. The user input 110 can be used to generate some of the synthetic training data for training the network policy agent described herein. The user input 110 can also be used to modify or adjust the network policy agent after the agent has already been trained based on existing data (such as the historic supply chain data 108). The user input 110 can be provided as natural language input, which can then be processed by the simulator 102 and used to determine how to adjust training of the network policy agent. As a result of this technique, the relevant user does not need experience in programming or coding schemas to correlate their user input 110 with different types of disruptions and their impacts on activities in the supply chain network. The simulator 102 can be trained to perform natural language processing techniques in order to correlate the user input 110 with the different types of disruptions and their impacts on the activities in the supply chain network. Therefore, the disclosed techniques allow the network policy agent to be continuously trained and improved with ongoing feedback and/or verification from relevant users in the supply chain network.

The random data 112 can include data about different types of disruptions that impact different supply chain networks (and/or the particular supply chain). The random data 112 can be used to generate solutions that may universally apply to different types of disruptions, regardless of how similar or different those disruptions are. For example, the random data 112 can be used to generate similar or same solutions for both employee strikes and hurricanes. As a result, the random data 112 can beneficially enhance generation of synthetic training data (e.g., augmentation of initial training data, such as augmentation of the historic supply chain data 108) so that the models described herein can generate similar solutions that can be applied to a variety of different real-world disruptions.

In block B, the simulator 102 can simulate the supply chain network with disruptions based on the training input(s). By simulating the supply chain network with the training input(s), the simulator 102 can generate a rich dataset of existing data and/or synthetic data that, when implemented by the network policy agent, can result in generation of optimal reorganizations of supply chain operations in the face of real-world disruptions.

As an illustrative example, sales data, shipping data, data tracking the supply chain of a manufacturer, data tracking goods (e.g., objects) between production, shipping, and warehousing entities, data tracking goods between warehousing entities and consumer-facing entities (e.g., retail stores), and/or demand at at least one consumer-facing entity may be used to simulate the supply chain network. This data may not include disruptions, in some implementations.

Therefore, as part of simulating the supply chain network, the simulator 102 can add disruptions to that data, thereby anticipating at least one potential disruption that may occur for the particular supply chain network. A network policy agent, as described in reference to block C, can then be trained to navigate similar scenarios and/or disruptions in the future, during runtime implementation.

Disruptions can be added to the data based on sampling historical distribution data (e.g., the historic supply chain data 108) associated with the particular supply chain network. The sampling can be performed based on and/or using historical boundaries and/or constraints. Different shapes of distribution may also be used to allow adversarial agents to cause one or more disruptions in the simulation and generate potential reorganizations of operations/policies for the supply chain network. The adversarial agents may also correlate disruptions between various activities or events in the supply chain over some period of time (e.g., a user-defined period of time, a threshold or other predetermined period of time). The adversarial agents may be configured to choose one or more disruptions based on their reward (e.g., higher rewarding disruptions may be chosen for purposes of simulation and training). Sometimes, instead of using the adversarial agents, the simulator 102 can employ a tagging system in which events can be labeled (e.g., automatically and/or by a relevant human stakeholder or other user) and then defined to correlate disruptions in the supply chain network.

As an example, an initial dataset of the training input(s) can be used to create a tuned simulation of the supply chain network. This dataset can be used to model manufacturing, shipping, and distribution of goods throughout the supply chain network. The dataset can also be used to model tracking costs, carbon emissions, and/or sales. Such simulating can be used to create nearly arbitrary amounts of synthetic training data by running a network policy agent with different seeds of information and perturbing those seeds in different ways. One or more configuration languages may be used to specify a scope of allowed changes to the training input(s) provided for purposes of simulating the supply chain network. For example, the configuration languages may include, but are not limited to, modifications to supply of goods, demand of goods, traffic or other transport costs, shipping delays, and/or any other conditions affecting the supply chain network.

In some implementations, simulating the supply chain network can include simulating the supply chain network in least optimal scenarios. Then, the network policy agent, as described further below, can be trained to identify and determine solutions that can assist the supply chain network to get out of such scenarios and other, similar real-world scenarios. These training techniques can be performed without using the adversarial agents that are described above.

Still referring to FIG. 1A, the simulator 102 can generate and train a network policy agent (e.g., machine learning model) based on the simulation (block C). The agent can be trained using the techniques described above. The agent can be trained to simulate various different types of disruptions to the supply chain network and determine one or more recommendations for improving operations of the supply chain network so that the supply chain network is not negatively impacted by future disruptions.

Sometimes, as part of generating and training the network policy agent, the simulator 102 can resample additional years of data or data from other sources. The resampling can depend on how the agent was built out using the training input(s) described above. Sometimes, existing data or the training input(s) that were initially used can be modified in some way to generate synthetic or otherwise fake histories, disruptions, and scenarios for the supply chain network. Then the agent can be iteratively trained with the modified data/input(s) in order to optimize performance of the agent during runtime use. As yet another example, the data used for training the agent and/or modifying/updating the agent can be programmatically modified and/or constrained to iteratively improve the ability of the agent to generate optimization solutions for the supply chain network, regardless of types of real-world disruptions that may arise in the future.

Sometimes, the agent can be trained to address disruptions associated with a particular supply chain network. Sometimes, the agent can be trained to address disruptions that may arise in a variety of different supply chain networks. As a result, the agent can be trained once and then deployed across many multi-agent systems, not just supply chain networks. The agent may also be robust in its ability to identify and/or anticipate different types of disruptions and generate solutions that can be applied to the different types of disruptions.

Once the agent is trained, the agent can be transmitted to the computer system 104 (block D). The agent can also be stored, such as in local memory and/or in a database/data store. The agent can then be retrieved during runtime use and implementation.

The computer system 104 can run the network policy agent to determine an impact of disruptions on the supply chain network (block E). Block E can be performed in real-time and/or during runtime use. The agent can be applied to real-time data about the particular supply chain network. The agent can be applied to determine upcoming, expected, possible, and/or currently-existing disruptions in the particular supply chain network.

In block F, the computer system 104 can generate at least one supply chain modification based on the network policy agent's output from block E. For example, the computer system can determine at least one change to a local policy of the supply chain network in order to avoid the supply chain network from experiencing the impact of an upcoming disruption that was determined in block E. As an illustrative example, the upcoming disruption can be a snowstorm. A projected impact of the snowstorm on a particular supply chain network can be a shortage of goods in a retail store, thereby causing higher consumer prices and reduced sales. To avoid the projected impact, the network policy agent can be used by the computer system 104 to generate a recommendation that the goods be shipped earlier than a current shipping time, from a production facility to a warehouse facility. By shipping the goods earlier between these 2 supply chain entities, a potential delay in shipping due to traffic and adverse weather conditions can be avoided, and the entire supply chain network can operate as optimal as possible, despite the upcoming disruption.

The computer system 104 can be part of a network of devices associated with a particular supply chain network. Therefore, the network policy agent can be deployed internally in the supply chain network. Sometimes, the computer system 104 can be remote from the supply chain network. As a result, output of the agent can then be provided to one or more relevant stakeholders who are internal to the affected supply chain network.

The computer system 104 can return the modification(s) for implementation in the supply chain network (block G). Returning the modification(s) may include transmitting the modification(s) to a computing device of a relevant stakeholder in the supply chain network. The stakeholder can review the modification and determine whether to implement the modification to adjust at least one local policy and/or schedule for the supply chain network. Sometimes, the computer system 104 may automatically update the at least one local policy and/or schedule for the supply chain network based on the returned modification(s) (e.g., based on factors such as a severity of an anticipated/upcoming disruption, a current state of the supply chain network, a likelihood of a potential disruption occurring, a severity of impact that an anticipated/upcoming disruption may have on the supply chain network, etc.). In some implementations, returning the modification(s) can include storing the modification(s) in local memory or the data store as described herein. The modification(s) can then be retrieved at a later time, presented to one or more relevant stakeholders of the supply chain network, and/or implemented to improve or otherwise optimize real-time operations of the supply chain network in anticipation of or during real-world disruptions.

Sometimes, the modification(s) can be used by a service, entity, or other system that may advise the entities in the supply chain network about how to make, improve, change, or optimize their decisions, local policies, and/or operations in response to real-world scenarios/disruptions. Such advisement (e.g., recommendations, automatic actions) can be provided by way of software that at least one of the simulator 102 and the computer system 104 downloads and installs. As described throughout this disclosure, in the illustrative example of the supply chain network, entities that may be affected by real-world disruptions and decisions made by the computer system 104 running the model can include, but are not limited to, shippers, manufacturers, suppliers, retail stores, warehouses, and/or customers. Refer to FIG. 1B below for further discussion.

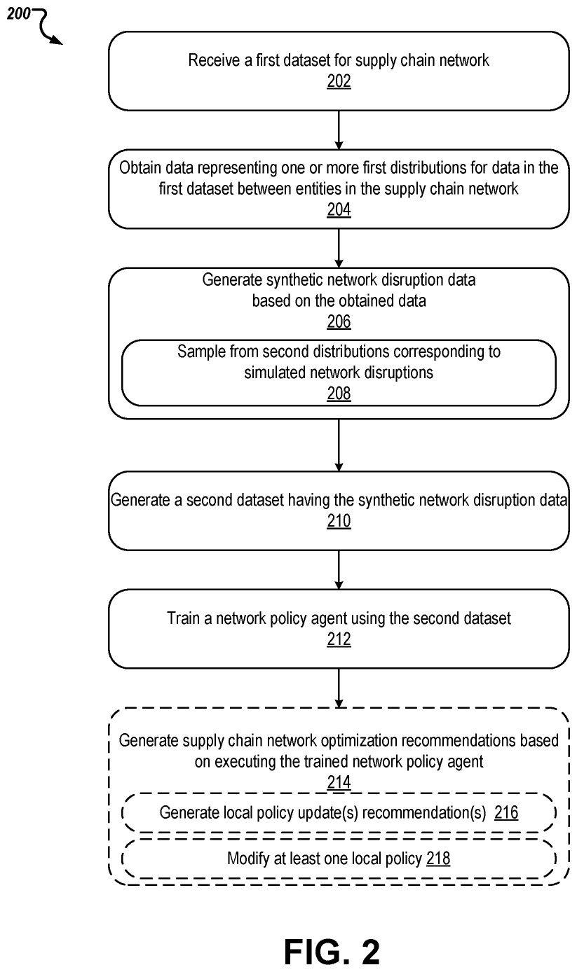

Refer to FIGS. 2-4 for further discussion about generating data for use in training the network policy agent, simulating disruptions in supply chain networks, training the network policy agent based on the simulated disruptions, and generating recommendations to reorganize operations and/or local policies of supply chain networks in anticipation of real-world disruptions.

FIG. 1B illustrates a block diagram of an example system 120 in a supply chain network. The system 120 is an illustrative use case in which the techniques described herein are implemented. The system 120 can represent a real-world supply chain in which multiple entities interact in the supply chain. Using the disclosed techniques, the entities can be identified and simulated with various types of disruptions. Local control policies of the identified entities can be adjusted, updated, or otherwise modified according to results from simulating such entities with the disruptions.

In the example system 120, multiple entities interact with each other in the supply chain network. For example, a factory 124 can produce or otherwise supply goods (e.g., products, items, produce) that can be transported to one or more warehouses 128 by one or more shipping entities 126. The one or more warehouses 128 may also provide the goods to one or more retail stores 130 via one or more shipping entities 126. One or more additional, fewer, or other entities may also interact with each other in the supply chain network. During training of a network policy agent as described herein, one or more disruptions can be injected into the system 120. For example, an adverse weather disruption can be injected between a shipping entity 126 and a warehouse 128. The network policy agent model described herein can be trained to determine how to respond to this disruption in order to maintain or otherwise improve operations of the shipping entity 126, the warehouse 128, and any other affected entities in the system 120 representing the supply chain network. Multiple disruptions may be injected throughout the system 120. The disruptions can affect same or different entities represented in the system 120. By simulating and modeling many different types of disruptions throughout the system 120, the system 120 can become robust and adapted to respond to any real-world disruption.

FIG. 1B is merely an illustrative use case of the disclosed techniques. The disclosed techniques can be implemented in a software platform, which can be used by various other types of entities in various other multi-agent networks/systems. The other multi-agent networks and systems can include, but are not limited to, power grid management systems, other types of energy grid management systems to balance supply and demand, or smart traffic coordination systems.

FIG. 2 is a flowchart of a process 200 for simulating disruptions in a supply chain network, such as in FIGS. 1A-B. The process 200 can be used to train at least one network policy agent (e.g., machine learning model) to simulate disruptions and determine responses to such disruptions that can optimize operations of an effected supply chain network. The process 200 can be performed by any appropriate system of one or more computers in one or more locations, e.g., the system 100 described above. The process 200 can also be performed by one or more other computing systems and/or networks programmed in accordance with this disclosure. For illustrative purposes, the process 200 is described from the perspective of a computer system.

Referring to the process 200, the computer system can receive a first dataset for a supply chain network in block 202. As an illustrative example, the computer system can receive an initial dataset representing movement of objects throughout a plurality of entities in a supply chain network (refer to FIG. 1B for further discussion about the supply chain network). The initial dataset can include travel time data representing how long it took (e.g., over some threshold amount of time, historically over time) for each object (e.g., goods, products) to be transported between entities in the supply chain network (e.g., from producer to warehouse, from warehouse to retail stores). The initial dataset may also include one or more features representing respective conditions of the supply chain network when the objects were transported. Such features can include, but are not limited to, weather conditions, employee conditions (e.g., strikes, availability of labor, vehicles, and other resources to transport the objects), traffic patterns, and other factors that may affect transportation of the objects between entities in the supply chain network. The initial dataset may include historic supply chain data associated with the supply chain network, as described above. Sometimes, the initial dataset may include historic supply chain data associated with another or multiple other supply chain networks. Furthermore, the initial dataset may include random data about various types of disruptions that may impact various supply chain networks.

In block 204, the computer system obtains data representing one or more first distributions for data in the first dataset between entities in the supply chain network. In the above example, the computer system can obtain data representing one or more first travel time distributions between entities in the supply chain network. Sometimes, the computer system can generate the first travel time distributions from the first dataset. The first travel time distributions can represent how long it took to transport the objects between entities considering the conditions of the supply chain network during the time of transport.

The computer system can generate synthetic network disruption data based on the obtained data in block 206. For example, the computer system may sample from second distributions corresponding to simulated network disruptions (block 208). In the above example, the computer system can sample from one or more second travel time distributions corresponding respectively to one or more simulated network disruptions. For example, the computer system may simulate one or more types of disruptions that may be experienced in the supply chain network, such as traffic, a labor strike, e.g., a trucker strike, or adverse weather conditions. By simulating such disruptions, the computer system can project how long it would take to transport the objects between entities in the supply chain network. The projected amount of time can be the second travel time distribution(s) mentioned above. To generate the synthetic network disruption data, the computer system can randomly sample from a set of second travel time distributions, where each second travel time distribution can correspond to a different simulated disruption. The computer system can also use one or more other rules and/or sampling techniques to select which of the second travel time distributions to use for generating the synthetic network disruption data. Sampling can beneficially provide for generating a robust dataset of synthetic data to be used in training a model that identifies and responds to various types of disruptions, including disruptions that historically appeared in the supply chain network as well as disruptions that may affect the supply chain network in the future (but otherwise do not appear in historic data associated with the supply chain network).

In some implementations, the computer system may generate the second travel time distributions from elements of the first dataset having conditions that meet one or more disruption criteria. The elements can include one or more data in the initial dataset that can be used for training purposes. For example, one element can indicate that package X was shipped between locations A and B in N hours, where N is larger than a normal time value. The disruption criteria can be set by a relevant stakeholder providing user input to the computer system. The user input can indicate one or more conditions for the disruption criteria. As an illustrative example, the user input can indicate that the second travel time distributions should be generating for conditions including snowstorms and hurricanes, but not trucker strikes or other labor shortages. As another example, the disruption criteria can specify disruptions that deliveries that were more delayed than average by a particular factor.

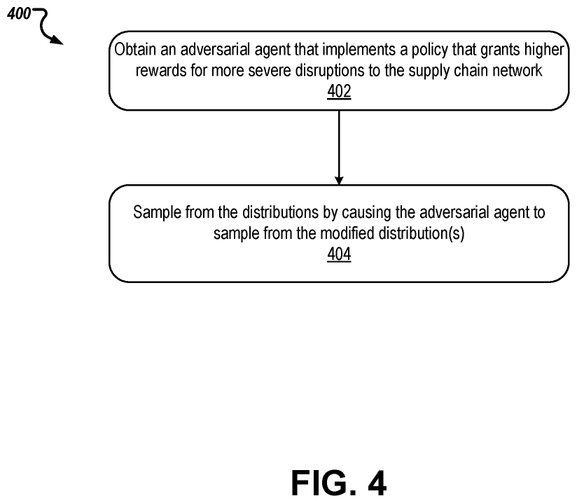

Sometimes, the computer system can generate the synthetic network disruption data by generating a plurality of correlated second travel time distributions. Generating the synthetic network disruption data may include generating a plurality of correlated (i) modified supply, (ii) modified demand, and (iii) modified traffic costs. The computer system can generate the synthetic data by stitching together a variety of data from the initial dataset. As a result, the synthetic data can include a robust set of possible disruptions and effects of those disruptions on the supply chain network, which can advantageously be used to train the model described herein to accurately model supply chain disruptions. Sometimes the correlated distributions can also be determined automatically by adversarial agents, as described further in reference to FIG. 4. Refer to FIGS. 3-4 for alternative sampling techniques that can be used in the process 200.

As described herein, the synthetic network disruption data can represent any sustained condition that may or may not be reflected in the historical data for the particular supply chain network. The synthetic network disruption data may represent events that adversely affect performance of the supply chain network according to a performance metric, e.g., average delivery time. The synthetic network disruption data can also represent increases in supply chain capabilities that may not be reflected in the historical data, e.g., a new route or a new factory, a new carrier or shipping entity becomes available to provide services in the supply chain network.

The computer system can generate a second dataset having the synthetic network disruption data in block 210. In other words, the computer system can inject the generated synthetic data into the initial dataset. Training the model described herein with the augmented dataset can beneficially make the model more robust in identifying various different types of disruptions and effects of those disruptions on the supply chain network (or other supply chain networks). As described in reference to FIGS. 3-4, the initial dataset can also be augmented with other synthetic data and/or data from other customers, supply chain networks, and/or relevant stakeholders.

In block 212, the computer system can train a network policy agent using the second dataset. For example, the second dataset can include the initial dataset augmented with the synthetic network disruption data. The network policy agent can be a machine learning model, as described herein. The network policy agent can be trained using machine learning techniques, including but not limited to reinforcement learning. As described herein, the network policy agent can be configured to simulate and model various types of disruptions to a supply chain network. Based on the simulated/modeled disruptions, the network policy agent can be used to determine at least one local policy update, modification, and/or recommendation that can be implemented in the supply chain network to improve and optimize operations of the network. The network policy agent can be specific to the particular supply chain network. Sometimes, the network policy agent can be trained for a variety of supply chain networks or a set of supply chain networks. As a result, one network policy agent can be advantageously trained once then deployed for various runtime applications, which can save computational resources and processing power during training and deployment.

Optionally, the computer system may generate at least one supply chain network optimization recommendation based on executing the trained network policy agent in block 214. The network policy agent can be executed in runtime, after deployment in the particular supply chain network. For example, the computer system can optionally generate at least one local policy update recommendation (block 216). As another example, the computer system can optionally modify at least one local policy (block 218). The computer system can execute the trained machine learning network policy agent for the supply chain network to identify potential disruptions to the supply chain network. The identified disruptions may include, but are not limited to, at least one of a storm, a hurricane, a shipment delay, an object production delay, and/or a trucker strike. Various other disruptions are also possible, as described herein. The computer system can then generate, based on the execution, recommendations to reorganize operations of the supply chain network. Sometimes, the generated recommendations may be applicable to more than one of the identified potential disruptions, where the identified potential disruptions may be different types of disruptions to the supply chain network.

As an illustrative example, the network policy agent can be used to determine safe driving conditions for self-driving vehicles. A self-driving vehicle may drive past a row of parked cars. If a door of one of the parked cars opens at a last second, there may not be enough time for the self-driving vehicle to avoid hitting the door. Thus, the network policy agent described herein can be trained with synthetic data to simulate scenarios in which the self-driving vehicle may hit an opening car door. Based on this simulation, the network policy agent can generate a recommendation that the self-driving vehicle move 2 inches away from the row of parked cars in anticipation of potentially opening car doors. During runtime, for example, the self-driving vehicle can drive a distance of 2 inches away from a row of parked cars.

FIG. 3 is a flowchart of a process 300 for training the model (e.g., network policy agent) of FIG. 2 with user input. The process 300 can be performed by the system 100 described above. The process 300 can also be performed by one or more other computing systems and/or networks described throughout this disclosure. For illustrative purposes, the process 300 is described from the perspective of a computer system.

Referring to the process 300, the computer system can maintain a mapping between different types of network disruptions and modifications to distributions in the initial dataset described in FIG. 2 (block 302). The mapping can indicate, for example, what effects the different types of network disruptions would likely have on the distributions in the initial dataset. As an illustrative example, the mapping can indicate that a snowstorm in a location between a producer and a warehouse can cause a truck travel time in that location between the producer and the warehouse to increase by 30 minutes.

The computer system can receive user input indicating selection of one or more of the different types of network disruptions in the mapping (block 304). A relevant stakeholder/user can be presented, at a computing device, various options to customize training of the network policy agent described in FIG. 2. Therefore, the user can indicate what types of disruptions to simulate/model, what disruptions may not be as relevant to the particular supply chain network, and various other factors/conditions. The user input can include natural language input having a label corresponding to at least one of the different types of network disruptions. Sometimes, the user input can include natural language input having a label corresponding to a nature of the one or more of the different types of network disruptions, a distribution of the one or more of the different types of network disruptions, and/or a severity of the one or more of the different types of network disruptions. Natural language specification of disruptions and/or conditions to simulate/model can make it easier for any type of relevant user to provide user input to train the network policy agent described herein. This is a no-coding way to train the network policy agent, which means that the relevant user does not need to have coding or programming knowledge in order to adjust and/or impact training of the network policy agent.

The computer system can then sample from the distributions using the mapping to implement a modification to the distribution corresponding to the user-selected type(s) of network disruption(s) (block 306). In other words, the computer system can identify, in the mapping, the user-selected type(s) of network disruption(s). The computer system can then identify what distribution modifications in the mapping correspond to the identified user-selected distribution(s). The computer system can randomly sample from the identified distribution modifications and inject those sampled modifications into the initial dataset described in FIG. 2.

The computer system can then augment the initial dataset with the sampled modifications and train the model using the augmented dataset, e.g., as described above with reference to FIG. 2.

As an illustrative example of the process 300, a relevant user in a particular supply chain can determine that hurricanes typically impact the particular supply chain. Therefore, the user can provide natural language user input indicating that hurricane disruptions are of interest to the particular supply chain. Whereas statisticians or programmers traditionally would code schemas to identify and correlate data in the initial dataset corresponding to hurricane disruptions, the disclosed techniques provide for the computer system to automatically process the natural language user input and then pull data together that corresponds to hurricane disruptions. Sometimes, the relevant user can provide human-level descriptions of what a disruption may look like in the particular supply chain network. Then the computer system can use natural language processing techniques to process the human-level descriptions and then simulate the user-identified disruption in the supply chain network (instead of or in addition to using seeded historic data about how the particular supply chain network was impacted in the past by one or more disruptions).

FIG. 4 is a flowchart of a process 400 for training the model (e.g., network policy agent) of FIG. 2 with adversarial agents. The process 400 can be performed by the system 100 described above. The process 400 can also be performed by one or more other computing systems and/or networks described throughout this disclosure. For illustrative purposes, the process 400 is described from the perspective of a computer system.

Referring to the process 400, the computer system can obtain at least one adversarial agent in block 402. The obtained adversarial agent can implement a policy that grants higher rewards for more severe disruptions to the supply chain network of FIG. 2. The adversarial agent can be a machine learning model that is configured to simulate/model disruptions that may be more severe or extreme than disruptions previously experienced by the supply chain network or represented in historic data associated with the supply chain network. The adversarial agent can therefore provide more insight into how the supply chain network can respond to such severe disruptions to maintain and optimize operations.

In block 404, the computer system can sample from the distributions of FIG. 2 by causing the at least one adversarial agent to sample from the second distribution(s). In other words, the adversarial agent can be deployed to sample from the second distributions and simulate them with the severe or extreme disruptions mentioned above. Sometimes, the adversarial agents can generate updated distributions based on these simulations.

The computer system can then the network policy agent with the sampling of distributions and/or simulations performed by the at least one adversarial agent.

Sometimes, the process 400 can be performed after the network policy agent is trained.

As an illustrative example, the process 400 can be performed to simulate higher-order disruptions and their impact(s) on the supply chain network. The higher-order disruptions can include natural disasters, pandemics, financial crises, housing crises, and/or one or more other severe or extreme disasters that may not be represented in the historical supply chain data and/or user input (e.g., refer to FIG. 3 for further discussion about the user input). By simulating these types of disruptions and modifying the distributions accordingly, the network policy agent can be better trained to accurately identify supply chain responses/operation reorganizations to a variety of types of disruptions in the real world.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method comprising:
receiving first dataset representing movement of objects through a plurality of entities in a supply chain network, wherein the first dataset includes (i) travel time data representing how long it took for each object to be transported between at least two entities in the supply chain network and (ii) one or more features representing respective conditions of the supply chain network when the objects were transported;
obtaining data representing one or more first travel time distributions between at the at least two entities in the supply chain network;
generating synthetic network disruption data including sampling from one or more second travel time distributions corresponding respectively to one or more simulated network disruptions;
generating a second dataset having the synthetic network disruption data; and
training a network policy agent using the second dataset.

Embodiment 2 is the method of embodiment 1, further comprising generating the first travel time distributions from the first dataset.

Embodiment 3 is the method of any one of embodiments 1-2, further comprising generating the second travel time distributions from elements of the first dataset having conditions meeting one or more disruption criteria.

Embodiment 4 is the method of any one of embodiments 1-3, wherein sampling from the one or more second travel time distributions comprises:
maintaining a mapping between different types of network disruptions and corresponding second travel time distributions;
receiving user input selecting one or more of the different types of network disruptions;
implementing, using the mapping, a modification to a first travel time distribution to generate a second travel time distribution; and
sampling from the second travel time distribution that corresponds to the user-selected type of network distribution to generate the synthetic network disruption data.

Embodiment 5 is the method of embodiment 4, wherein the user input selecting the one or more of the different types of network disruptions comprises natural language input indicating the one or more of the different types of network disruptions.

Embodiment 6 is the method of embodiment 5, further comprising identifying a label corresponding to the one or more of the different types of network disruptions based on processing the user input with natural language processing techniques.

Embodiment 7 is the method of embodiment 5, further comprising identifying a label corresponding to a nature of the one or more of the different types of network disruptions, a distribution of the one or more of the different types of network disruptions, and a severity of the one or more of the different types of network disruptions.

Embodiment 8 is the method of any one of embodiments 1-7, further comprising:
obtaining an adversarial agent that implements a machine learned policy that grants rewards exceeding a threshold reward level for more severe disruptions to the supply chain network,
wherein sampling from the one or more second travel time distributions comprises causing the adversarial agent to sample from the second travel time distributions.

Embodiment 9 is the method of any one of embodiments 1-8, wherein generating the synthetic network disruption data comprises generating a plurality of correlated modified travel time distributions.

Embodiment 10 is the method of any one of embodiments 1-9, wherein generating the synthetic network disruption data further comprises generating a plurality of correlated (i) modified supply, (ii) modified demand, and (iii) modified traffic costs for the supply chain network.

Embodiment 11 is the method of any one of embodiments 1-10, further comprising:
executing the trained network policy agent for the supply chain network to identify potential disruptions to the supply chain network; and
generating, based on execution of the trained machine learning network policy agent and identification of the potential disruptions to the supply chain network, recommendations to reorganize operations of the supply chain network.

Embodiment 12 is the method of embodiment 11, wherein the identified potential disruptions include a storm, a shipment delay, an object production delay, or a labor strike.

Embodiment 13 is the method of embodiment 11, wherein the generated recommendations apply to more than one of the identified potential disruptions, wherein each of the identified potential disruptions is a different type of disruption to the supply chain network.

Embodiment 14 is the method of any one of embodiments 1-13, wherein the first dataset includes historic supply chain data associated with the supply chain network.

Embodiment 15 is the method of any one of embodiments 1-14, wherein the first dataset includes historic supply chain data associated with at least one other supply chain network, wherein the at least one other supply chain network is different than the supply chain network.

Embodiment 16 is the method of any one of embodiments 1-15, further comprising returning the trained network policy agent for runtime use in the supply chain network.

Embodiment 17 is a system comprising: one or more computers and one or more storage devices storing instructions that are operable, when executed by the one or more computers, to cause the one or more computers to perform the method of any one of embodiments 1 to 16.

Embodiment 18 is a computer storage medium encoded with a computer program, the program comprising instructions that are operable, when executed by data processing apparatus, to cause the data processing apparatus to perform the method of any one of embodiments 1 to 16.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving first dataset representing movement of objects through a plurality of entities in a supply chain network, wherein the first dataset includes (i) travel time data representing how long it took for each object to be transported between at least two entities in the supply chain network and (ii) one or more features representing respective conditions of the supply chain network when the objects were transported;
obtaining data representing one or more first travel time distributions between at the at least two entities in the supply chain network;
generating synthetic network disruption data including sampling from one or more second travel time distributions corresponding respectively to one or more simulated network disruptions;
generating a second dataset having the synthetic network disruption data; and
training a network policy agent using the second dataset.

2. The method of claim 1, further comprising generating the first travel time distributions from the first dataset.

3. The method of claim 1, further comprising generating the second travel time distributions from elements of the first dataset having conditions meeting one or more disruption criteria.

4. The method of claim 1, wherein sampling from the one or more second travel time distributions comprises:
maintaining a mapping between different types of network disruptions and corresponding second travel time distributions;
receiving user input selecting one or more of the different types of network disruptions;
implementing, using the mapping, a modification to a first travel time distribution to generate a second travel time distribution; and
sampling from the second travel time distribution that corresponds to the user-selected type of network distribution to generate the synthetic network disruption data.

5. The method of claim 4, wherein the user input selecting the one or more of the different types of network disruptions comprises natural language input indicating the one or more of the different types of network disruptions.

6. The method of claim 5, further comprising identifying a label corresponding to the one or more of the different types of network disruptions based on processing the user input with natural language processing techniques.

7. The method of claim 5, further comprising identifying a label corresponding to a nature of the one or more of the different types of network disruptions, a distribution of the one or more of the different types of network disruptions, and a severity of the one or more of the different types of network disruptions.

8. The method of claim 1, further comprising:
obtaining an adversarial agent that implements a machine learned policy that grants rewards exceeding a threshold reward level for more severe disruptions to the supply chain network,
wherein sampling from the one or more second travel time distributions comprises causing the adversarial agent to sample from the second travel time distributions.

9. The method of claim 1, wherein generating the synthetic network disruption data comprises generating a plurality of correlated modified travel time distributions.

10. The method of claim 1, wherein generating the synthetic network disruption data further comprises generating a plurality of correlated (i) modified supply, (ii) modified demand, and (iii) modified traffic costs for the supply chain network.

11. The method of claim 1, further comprising:
executing the trained network policy agent for the supply chain network to identify potential disruptions to the supply chain network; and
generating, based on execution of the trained machine learning network policy agent and identification of the potential disruptions to the supply chain network, recommendations to reorganize operations of the supply chain network.

12. The method of claim 11, wherein the identified potential disruptions include a storm, a shipment delay, an object production delay, or a labor strike.

13. The method of claim 11, wherein the generated recommendations apply to more than one of the identified potential disruptions, wherein each of the identified potential disruptions is a different type of disruption to the supply chain network.

14. The method of claim 1, wherein the first dataset includes historic supply chain data associated with the supply chain network.

15. The method of claim 1, wherein the first dataset includes historic supply chain data associated with at least one other supply chain network, wherein the at least one other supply chain network is different than the supply chain network.

16. The method of claim 1, further comprising returning the trained network policy agent for runtime use in the supply chain network.

17. A system comprising:
one or more computers and one or more storage devices storing instructions that are operable, when executed by the one or more computers, to cause the one or more computers to perform operations comprising:
receiving first dataset representing movement of objects through a plurality of entities in a supply chain network, wherein the first dataset includes (i) travel time data representing how long it took for each object to be transported between at least two entities in the supply chain network and (ii) one or more features representing respective conditions of the supply chain network when the objects were transported;
obtaining data representing one or more first travel time distributions between at the at least two entities in the supply chain network;
generating synthetic network disruption data including sampling from one or more second travel time distributions corresponding respectively to one or more simulated network disruptions;
generating a second dataset having the synthetic network disruption data; and
training a network policy agent using the second dataset.

18. The system of claim 17, wherein the operations further comprise generating the second travel time distributions from elements of the first dataset having conditions meeting one or more disruption criteria.

19. The system of claim 17, wherein sampling from the one or more second travel time distributions comprises:
maintaining a mapping between different types of network disruptions and corresponding second travel time distributions;
receiving user input selecting one or more of the different types of network disruptions;
implementing, using the mapping, a modification to a first travel time distribution to generate a second travel time distribution; and
sampling from the second travel time distribution that corresponds to the user-selected type of network distribution to generate the synthetic network disruption data.

20. One or more non-transitory computer storage media encoded with computer program instructions that when executed by one or more computers cause the one or more computers to perform operations comprising:
receiving first dataset representing movement of objects through a plurality of entities in a supply chain network, wherein the first dataset includes (i) travel time data representing how long it took for each object to be transported between at least two entities in the supply chain network and (ii) one or more features representing respective conditions of the supply chain network when the objects were transported;
obtaining data representing one or more first travel time distributions between at the at least two entities in the supply chain network;
generating synthetic network disruption data including sampling from one or more second travel time distributions corresponding respectively to one or more simulated network disruptions;
generating a second dataset having the synthetic network disruption data; and
training a network policy agent using the second dataset.
